(19) United States
(12) Patent Application Publication
(10) Pub. No.: US 2019/0221102 A1
(43) Pub. Date: Jul. 18, 2019

(54) WATER PING: A FLUID CONSUMPTION INDICATION SYSTEM AND METHOD

(71) Applicant: Leica Biosystems Imaging, Inc., Vista, CA (US)

(72) Inventors: Ange Trazier Goueti, Ocoee, FL (US); Elizabeth Goueti, Ocoee, FL (US)

(21) Appl. No.: 16/208,560

(22) Filed: Dec. 4, 2018

Related U.S. Application Data
(60) Provisional application No. 62/630,451, filed on Feb. 14, 2018.
(60) Provisional application No. 62/594,160, filed on Dec. 4, 2017.

(51) Int. Cl. G08B 21/24; G01G 17/04; G08B 5/36

(52) U.S. Cl. CPC G08B 21/24; G08B 5/36; G01G 17/04

(57) ABSTRACT

A method and apparatus relating to a drink coaster is described. The drink coaster provides alerts or information to a user relating to consumption of a drink being placed on the coaster.

### CROSS REFERENCE TO RELATED APPLICATIONS

This application claims the benefit of U.S. Provisional Application No. 62/594,160 filed on Dec. 4, 2017 by Ange Goueti, entitled FLUID CONSUMPTION INDICATION SYSTEM AND METHOD and this application also claims the benefit of U.S. Provisional Application No. 62/630,451 filed on Feb. 14, 2018, by Ange Goueti, entitled FLUID CONSUMPTION INDICATION SYSTEM AND METHOD. Both of these applications are herein incorporated by reference in their entirety.

### FIELD OF THE INVENTION

The invention is related to a smart water coaster that connects with a compatible app. The app tracks how much water a user drinks and reminds the user to drink more with several different outputs. The outputs from the device include light and sound, additional outputs include sending alerts through other Bluetooth or WIFI connected devices.

In one exemplary embodiment the system includes an electronic coaster and a smartphone app. Together the coaster and smartphone app will help a user to determine optimal daily water consumption, as well as assist the user to consume that amount. The system is particularly useful for users who regularly work at a workstation, desk or other location.

The software calculates a target water intake within a time frame based on a user's weight, activity, and other given or calculated details.

### BACKGROUND

For many people who may have a variety of health issues it is desirable to track the amount of fluids that they drink each day. In doing so, people often lose track of the amount of fluids that they take in. Therefore, it would be desirable to have an automated system to track the amount of fluids that a person drinks each day. Additionally, it would be desirable if there were a way to remind a person that they need to drink more throughout the day if they tend to be lagging their goals for fluid intake. Some solutions such as smart cups and the like do track consumption through a mobile phone app for example. However, these prior solutions did not offer sound and light notification from the device to remind users to drink more.

The foregoing description is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exemplary embodiment of a smart coaster depicting various views thereof.

FIG. 2 is an exemplary embodiment of a generalized system process.

FIG. 3 is an exemplary process diagram of a base daily target logic.

FIG. 4 is an exemplary process diagram a proportion of consumption logic.

FIG. 5 is an exemplary process diagram a schedule of interaction logic.

FIG. 6 is an exemplary process diagram a monitoring logic.

FIG. 7 is an exemplary process diagram an alerts logic.

FIG. 8 is an exemplary process diagram of the overall system logic.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

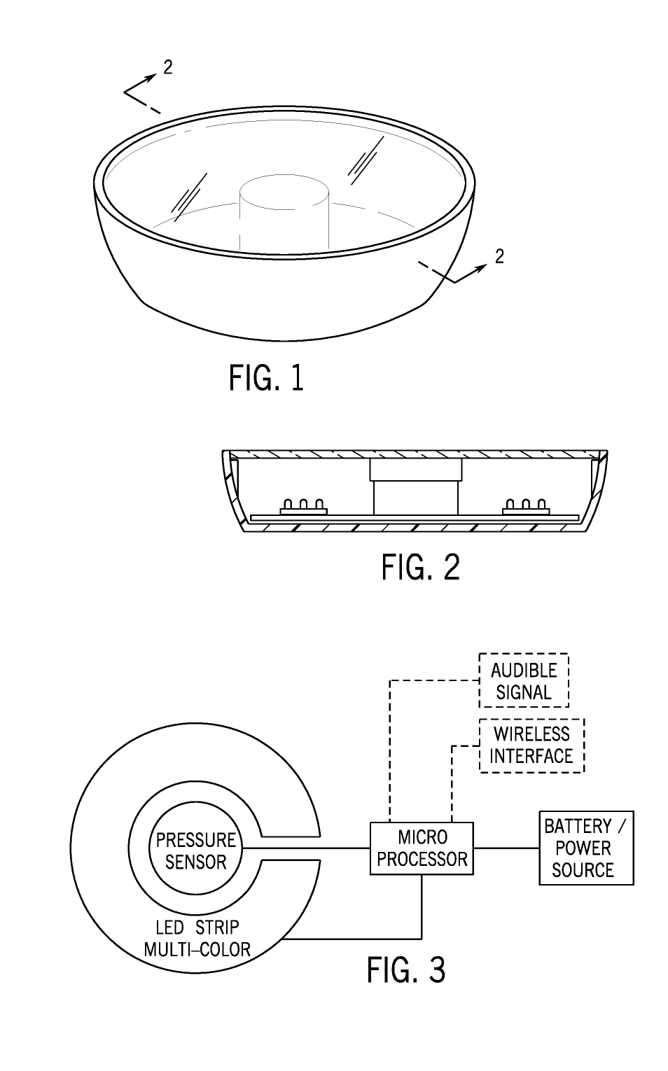

Referring now to FIG. 1, a coaster 100 includes electronics therein to enable the use of the coaster to track the amount of fluid that a user is taking in throughout a period, such as but not limited to a day or any other period of time. Coaster 100 includes a base 110 with a platform 120 for holding a beverage container. Platform 120 is coupled to a transducer for sensing the weight of the container and its contents. The transducer is in communication with any logic based electronics such as but not limited to a processor like an Arduino processor or any other logic based electronics. The processor includes inputs and output channels as well as communication channels. The communication channels may be used for a variety of connections including wired connections or wireless connections such as but not limited to WiFi and Bluetooth. The communications channels are used to communicate with a mobile app (running on a mobile phone or tablet) or other computing or information management device.

In accordance with an exemplary embodiment information about the weight of the container placed on the coaster is sent to other devices. The original or tare weight of the container may be from a database having information about the weight of different types of containers, may be weighed and registered in advance by a user using the coaster itself or another scale, or may be entered into the app by hand. In other exemplary embodiments the original or tare weight is not needed, rather changes in the weight of the container are monitored. As a user drinks fluid from the container information derived from the changes of weight of container over time is sent to other connected devices, such as but not limited to the mobile phone app or the like. In one exemplary embodiment, the coaster includes lights 130, which may be LEDs or the like. Lights 130 are activated based on information derived from the changes of weight of the container over time and other inputs. For example, if a user is deemed not to be drinking at a fast enough rate by the software on the mobile app, lights 130 may be activated. Lights 130 may be activated with a variety of signals, for example always on, blinking, or blinking at a variety of rates.

In accordance with some exemplary embodiments coaster 100 may generate sound alerts based on information derived from the changes of weight of the container over time and other inputs. Sound alerts may emanate from speaker 140 built into coaster 100. Alternatively, sound alerts may be triggered on other connected devices, such as through the software running on the mobile phone. Sound alerts may come in a variety of forms to communicate various information including, but not limited to reminders to drink more or other information.

In some exemplary embodiments, coaster 100 is capable of receiving input from external devices, such as but not limited to the mobile app, instructing coaster 100 to turn on lights 130 or generate sound through speaker 140.

In one exemplary embodiment the system includes an electronic coaster and a smartphone app. Together the coaster and smartphone app will help a user to determine optimal daily water consumption, as well as assist the user to consume that amount. The system is particularly useful for users who regularly work at a workstation, desk or other location.

In an exemplary embodiment, the system fulfills several basic functions, as depicted in FIG. 2. For example, the software is able to calculate a daily target based on a user's weight or based on a user's activity, etc. In an exemplary embodiment, the app or a user determines what part of a user's target consumption will be managed. In some embodiments, the user or the app may determine what part of the day it will be interacting with the user and monitoring the user's usage. Also, the app may track usage over time and can track and monitor a user's progress toward both daily and long-term goals over time. The app will regularly provide messages to a user providing information as to progress toward goals. In accordance with some exemplary embodiments, the app is configured to make calculations to determine whether to provide alerts to a user based on the user's fluid consumption and other factors. In accordance with other exemplary embodiments the same determinations and calculations may be made by software running on a processor or other logic circuit in coaster 100, or may the software may be run on other devices.

In accordance with an exemplary embodiment, the system may determine a base daily target for water consumption, based on various physical properties of a user, as depicted in FIG. 3. In some embodiments the software may also adjusts for variations based on things such as but not limited to lifestyle and temporary physical circumstances. The scenario below illustrates some of the ways those adjustments could be made.

As one example:
A base daily water target consumption may be 12 cups (96 oz).
If the user weighs more than 180 lbs add 1 oz for every pound over 180 lbs. So 96 oz+(1 oz/lb)*(190 lbs−180 lbs)=106 oz
If the user will be exercising add 1 oz for every half an hour of exercise. So 106 oz+(2 oz/hr)*(0.75 hr)=107.5 oz.
A nursing woman should consume an extra 30%. So (107.5 oz)*(1.3)=139.75 oz.
Similar adjustments could be defined for people who are very tall or very short, people who are fasting, or if the weather is particularly hot or cold.

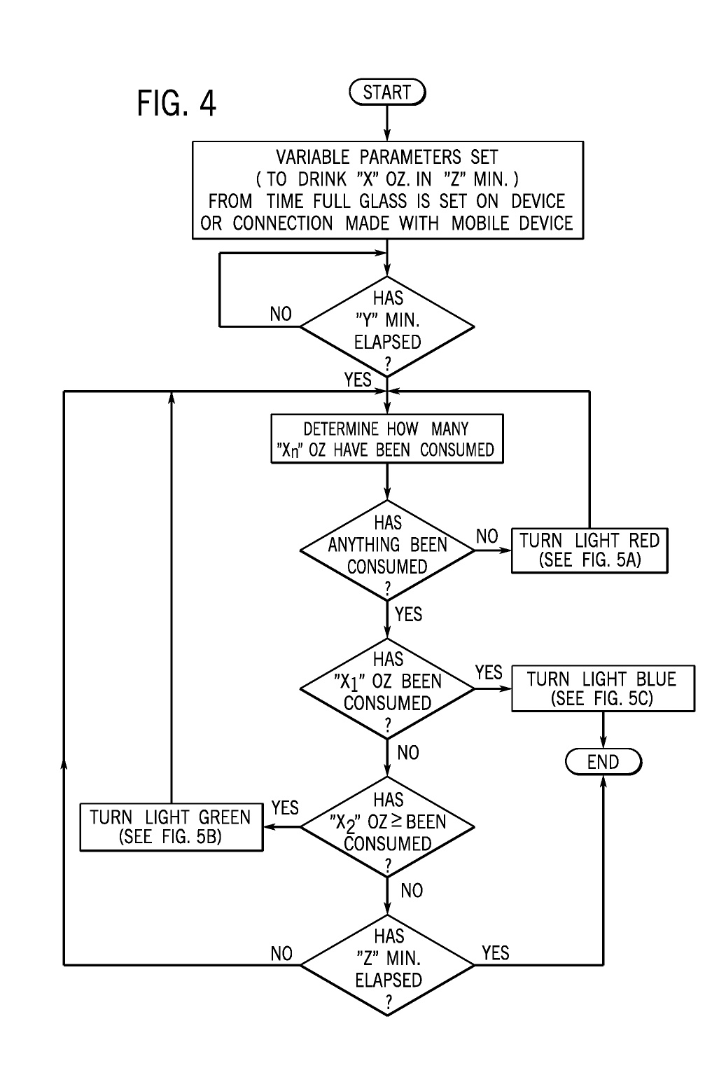

The system is expected to be used primarily as the user sits at a desk or other workstation, therefore it may not manage 100% of his daily water consumption. In this case, as depicted in FIG. 4, a base proportion of the daily target is delegated to the system. This may be further refined for new users, to allow an easing in period.

As one example:
Start with the assumption that a person will be at his desk for 7 hours a day, and that in that time he should consume 60% of his daily allowance. So (96 oz)*(0.6)=57.6 oz.
   Convert that amount into an hourly rate, so (57.6 oz)/(7 hrs)=8.25 oz/hr.
Since it might be overwhelming for a new user to drink 8.25 oz/hr, define an ‘easing in’ period, so in the first week that a person is using the system they would be allocated 70% of their hourly target. So (8.25 oz)*(0.7)=5.75 oz. In the second week they would be allocated 80% of their hourly target, so (8.25 oz)*(0.8)=6.5 oz. And so on.

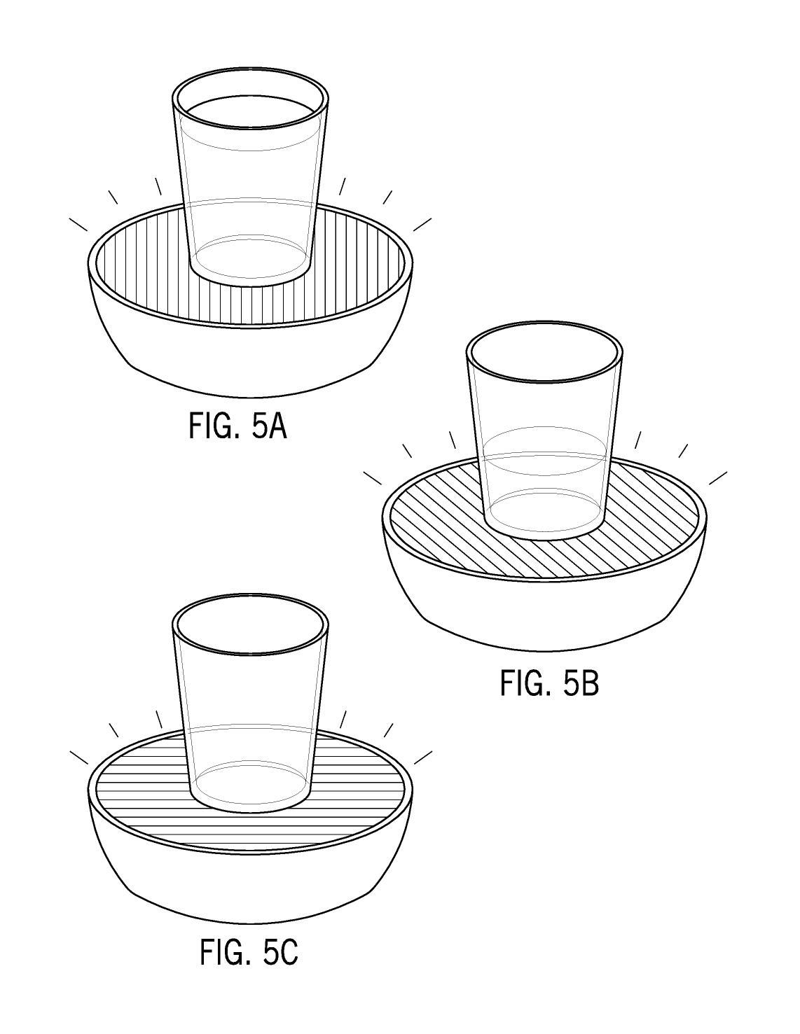

Because in some embodiments, the system is expected to be used primarily as the user sits at their desk, the system will recognize when the user will not be at their desk and adjust how to manage their drinking while they are at their desk, as depicted in FIG. 5. The system may have the ability to synchronize with the user's calendar to adjust for meetings, when the user will be away from their desk. In some exemplary embodiments, the coaster can determine if the user is close to it, based on the Bluetooth connection of a user's mobile device. Further, in some exemplary embodiments, the system may monitor and adjust to the user's patterns of comings and goings. In accordance with various embodiments, the device and its software may be configured to be used by users other than desk workers. For example a version of the coaster may be configured for usage in a car or in a workshop, etc.

As one example:
If the user will be in a meeting for two hours—their desk time would only be five hours for the day, so the amount they should be drinking while they are at their desk should increase, so if their hourly rate was 6 oz (based on previous calculations), which is equivalent to (6 oz)*(7 hrs)=52 oz for the day. But now there is only 5 hours in which to drink it, so (52 oz)/(5 hrs)=10.5 oz/hr.
Similarly, if the user arrived a work late—the bluetooth connection would detect that and adjust her hourly allotment in a similar fashion as above.
If the user is away from their desk between 3 PM and 4 PM three times in a row—the system would notice that, and would assume that now the user only sits by her desk for 6 hours a day, and would adjust her hourly rate accordingly. The system would also notice if that pattern has reversed, and if the user was again by her desk twice in a row between 3 PM and 4 PM it would go back to assuming that she is at her desk 7 hours a day when calculating hourly rate.

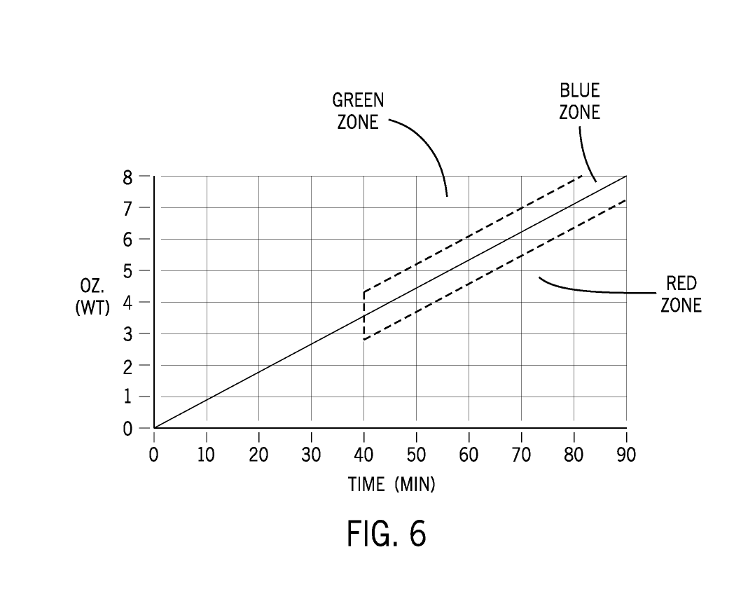

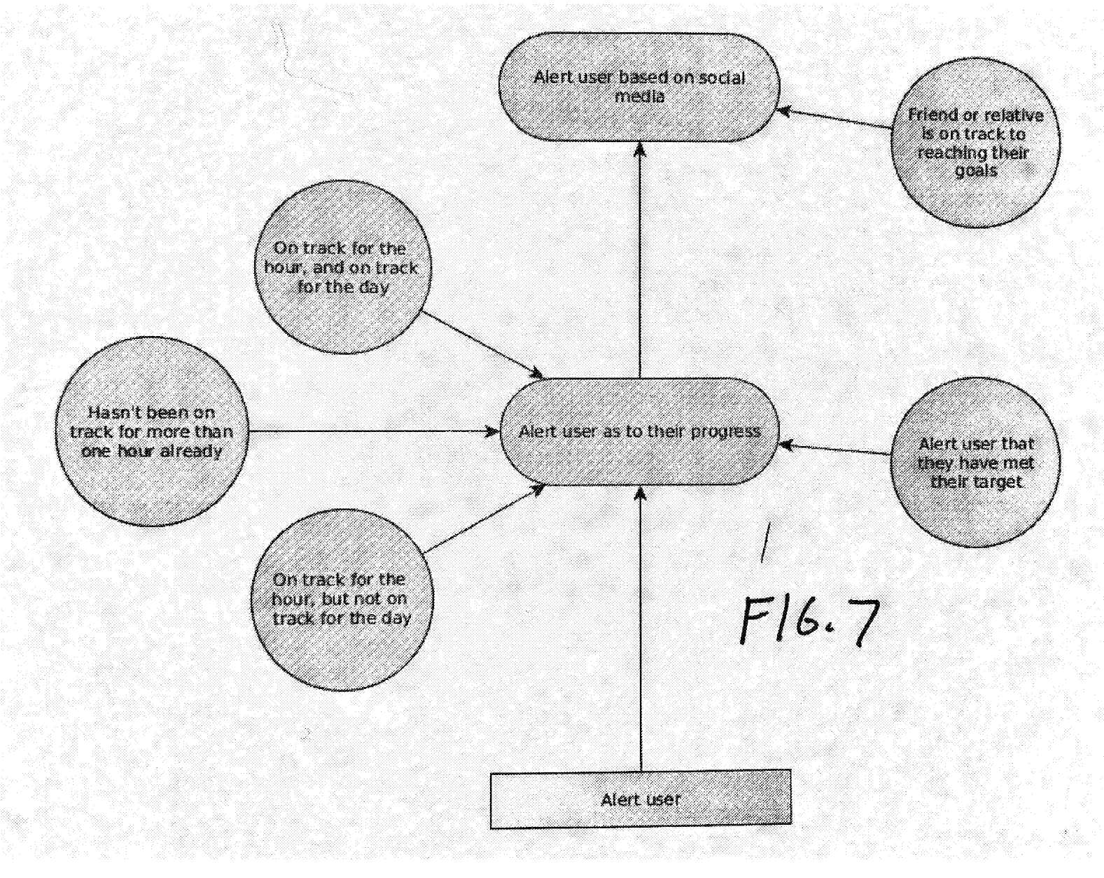

In accordance with an exemplary embodiment, the coaster will be able to weigh the user's cup, in order to determine how much water was consumed with the internal transducer, as depicted in FIG. 6.

As one example:
At 10 AM the weight of the cup on the coaster was 45 oz, and at 11 AM the weight is 32 oz, the system would determine that the user drank 13 oz in the last hour.

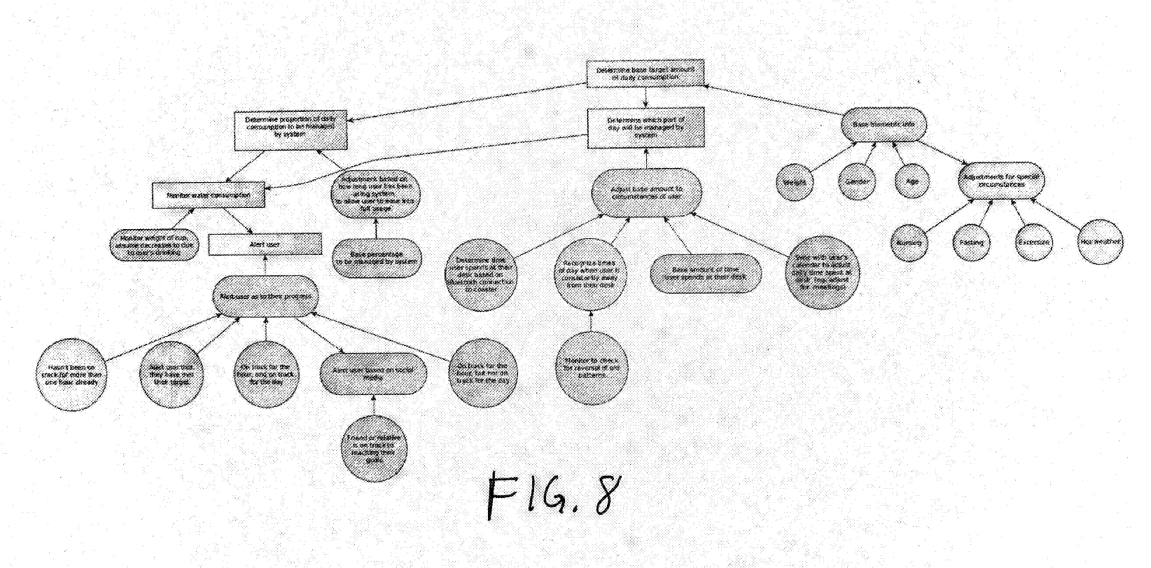

In accordance with an exemplary embodiment, the system will alert the user by means of colored lights, or icons if the user is on track to meet their goals, if they have met them, and if they are failing to meet them, as depicted in FIG. 7. In an alterrnative embodiment, the system may be configured to integrate with social media to inform users if their friends and family are meeting their goals.

As one example:
A user is supposed to drink 60 oz in a 6 hour period (based on calculations above), so 10 oz per hour. If after 3 hours at their desk they have consumed 30 oz, they are on track for their daily goal. The coaster would display a blue light.
If after 3 hours they have only consumed 20 oz, but in the last hour they consumed 10 oz—the coaster would display a green light.
If after 3 hours they have only consumed 20 oz, and in the last two hours they only consumed 4 oz each—the coaster would display a red light.
If the user met their daily goal—the coaster could display a show of various light patterns as a reward.
The app could also notify the user that their mother has reached her goals, and display an icon to the user.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. In addition, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of using a coaster to monitor and alert a user of fluid intake comprises:
receiving input comprising user information and external data;
observing a current amount of fluid in a container resting on said coaster by determining a weight of the container;
monitoring the weight of the fluid for changes and determining a rate of fluid consumption by said user;
determining whether or not to activate an alert to notify the user to consume more water based on the received input, the weight of the water, and the rate of water consumption and if the determination is to activate the alert, at least one of changing a color of an LED of the coaster or activating an audible alert; and
recording the received input, changes in the amount of water, the weight of the water and the determination in a user profile.
